(19) United States
(12) Patent Application Publication
(10) Pub. No.: US 2007/0106982 A1
(43) Pub. Date: May 10, 2007

(54) Method, apparatus, and computer program product for model based traceability

(75) Inventors: Keyur D. Dalal, Cury, NC (US); Kevin Edward Kelly, Raleigh, NC (US); Jan Joseph Kratky, Raleigh, NC (US); Steven Keith Speicher, Apex, NC (US); Mark Douglas Weitzel, Durham, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/267,223

(22) Filed: Nov. 4, 2005

(51) Int. Cl. G06F 9/44

(52) U.S. Cl. 717/128

(57) ABSTRACT

A model based traceability framework is provided in an integrated development environment. The model based framework is embeddable, or deployable, in any application or plugin within the integrated development environment. A database provides scalable persistence of the model and traceability links created using the model. The framework comprises an underlying model that is created by an administrator through a table schema. Tools using the framework allow the creation and management of traceability links, which may be created during code generation or manually through a user interface. An administrator manages the model by creating and maintaining artifact information, traceability link types, and traceability link information in tables. A traceability tool, which may a standalone application or a plugin to an existing tool, allows users to create, update, and delete traceability links. The traceability tool may also allow users to query traceability links.

### BACKGROUND OF THE INVENTION

1. Field of the Invention

The present invention relates generally data processing and, in particular, to providing a model based traceability framework in a software development environment.

2. Description of the Related Art

Traceability is a technique for managing and analyzing impact, coverage, and derivation of artifacts in a software development project. An artifact is any item that is used or produced in a software development project. The specific items are defined by each project for its own needs. For example, one project may consider complete source files as artifacts, while another project may consider individual methods as artifacts.

A traceability link is a one-way relationship between two artifacts. A traceability link is a general association that indicates that the source of the link is used to either create or modify the target of the link. For example, a requirement is used to create a model element, which is also used to create specific instances of code artifacts. As another example, a defect report is used to modify existing requirements, model elements, or code artifacts.

Typically, traceability management and analysis are cumbersome processes. Software developers often manage traceability by recording traceability links on large whiteboards or by manual data entry into databases, which are not integrated into the software development environment.

### BRIEF SUMMARY OF THE INVENTION

The present invention recognizes the disadvantages of the prior art and provides a traceability mechanism for model based traceability. The traceability mechanism provides a traceability model. The traceability mechanism creates a plurality of traceability links based on the traceability model. The traceability system provides a tool for managing the plurality of traceability links.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which aspects of the present invention may be implemented;

FIG. 2 is a block diagram of a data processing system in which aspects of the present invention may be implemented;

FIG. 3 is a diagram illustrating the functionality of a model based traceability engine in accordance with exemplary aspects of the present invention;

FIGS. 4A-4G are example screens of display of traceability tool user interfaces in accordance with exemplary aspects of the present invention;

FIG. 5 is a block diagram illustrating a model based traceability engine exposed in an application programming interface and persisted in a database in accordance with exemplary aspects of the present invention;

FIG. 6 is a block diagram illustrating a model based traceability engine providing traceability via a database instance in accordance with exemplary aspects of the present invention;

FIG. 7 is a block diagram illustrating a model based traceability engine providing traceability on the same database instance with a different schema qualifier in accordance with exemplary aspects of the present invention;

FIG. 8 is a block diagram illustrating a model based traceability engine providing traceability on the same database instance with a custom schema in accordance with exemplary aspects of the present invention;

FIG. 9 illustrates example table schemas for model based traceability in accordance with exemplary aspects of the present invention;

FIG. 10 depicts an example of traceability information in accordance with exemplary aspects of the present invention;

FIG. 11 illustrates a physical view of example tables formed from traceability information in accordance with exemplary aspects of the present invention;

FIG. 12 is a flowchart illustrating operation of a traceability application in accordance with exemplary aspects of the present invention; and

FIG. 13 is a flowchart illustrating the operation of querying traceability links in accordance with exemplary aspects of the present invention.

### DETAILED DESCRIPTION OF THE INVENTION

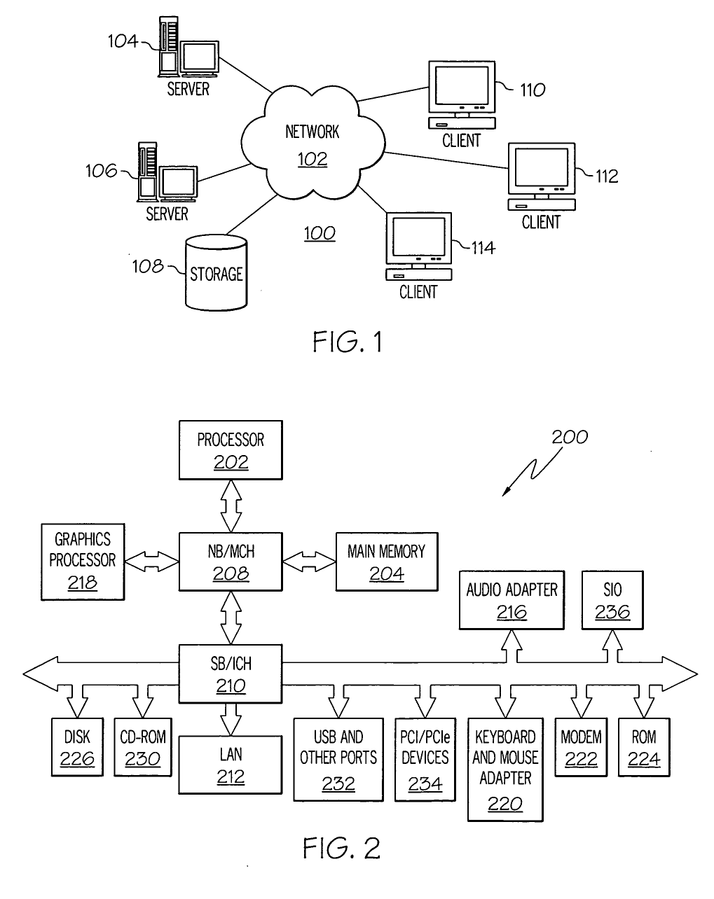

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

Server 104 or server 106 may provide server applications for an integrated development environment. Clients 110, 112, 114 may provide client applications that interact with the server software to access software development tools in the integrated development environment. An integrated development environment is a set of programs that run from a single user interface. For example, programming languages often include a text editor, a compiler, and a debugger, which are all activated and function from a common menu.

In accordance with exemplary aspects of the present invention, a model based traceability framework is provided in an integrated development environment. The model based framework is embeddable, or deployable, in any application or plugin within the integrated development environment. A database provides scalable persistence of the model and traceability links created using the model.

Traceability links are used, for example, for requirements, defects, documentation, etc. For an artifact, for instance, a traceability link may trace back to the code that created the artifact. As a particular example, a defect tracking system that extracts bug reports may use traceability to trace bug reports to the code that caused the bugs.

The framework comprises an underlying model that is created by an administrator through a schema or meta model. Tools using the framework allow the creation and management of traceability links, which may be created during code generation or manually through a user interface. The tools allow a user to query traceability links by identification (ID), uniform resource identifier (URI), UREF, which is a reference to a uniform resource locator (URL), traceability type, and who/what/when criteria, for example.

An administrator manages the model by creating and maintaining artifact information, traceability link types, and traceability link information in tables. Traceability link types may include, for example, artifact-to-artifact links, model-to-model links, model-to-code links, and artifact-to-model/code links. A traceability tool, which may a standalone application or a plugin to an existing tool, allows users to create, update, and delete traceability links. The traceability tool may also allow users to query traceability links. In addition, the traceability tool may mark links as suspect.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and peripheral component interconnect (PCI) and PCI express (PCIe) devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system. In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

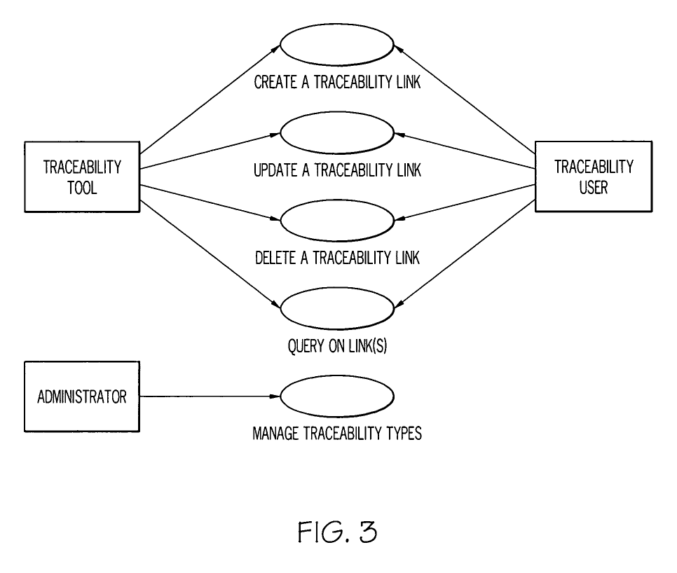

FIG. 3 is a diagram illustrating the functionality of a model based traceability engine in accordance with exemplary aspects of the present invention. An administrator manages traceability types. A traceability tool allows a traceability user to create, update, and delete traceability links. The traceability tool also allows users to query on links. This engine, while simple, provides a powerful tool for managing traceability links in an integrated development environment. The client applications are capable of presenting and modifying traceability links in a manner that is very useful within the integrated development environment.

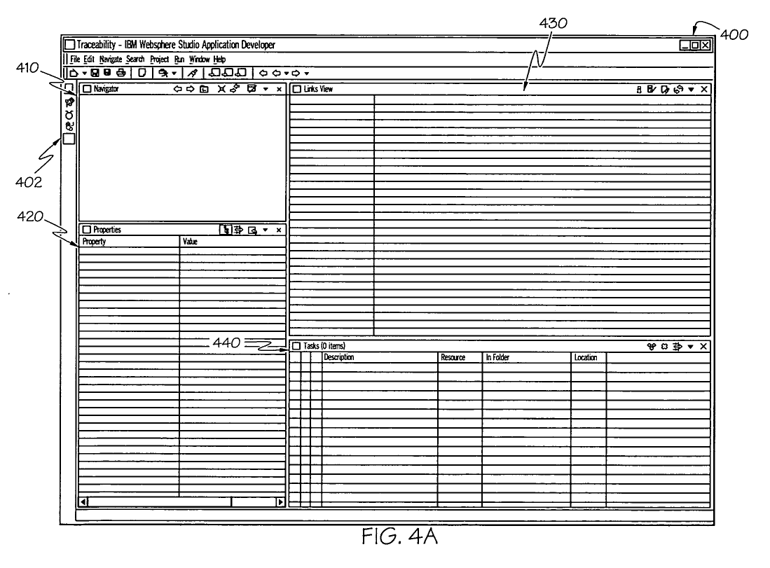

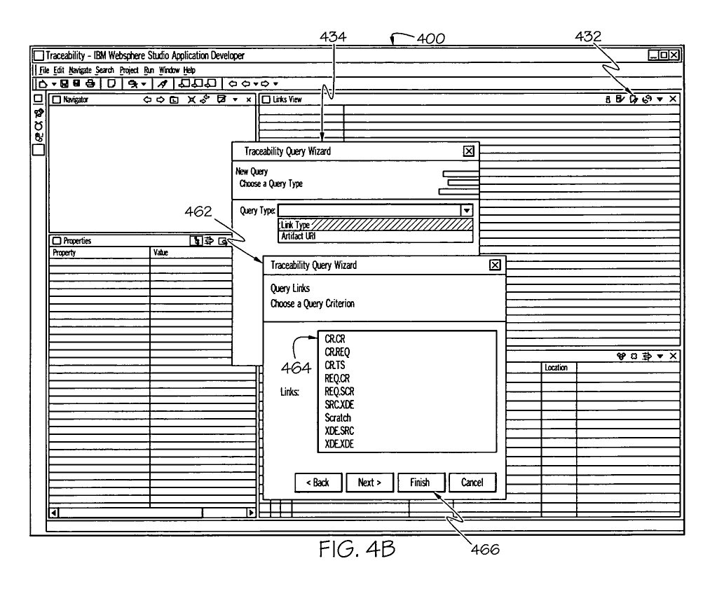

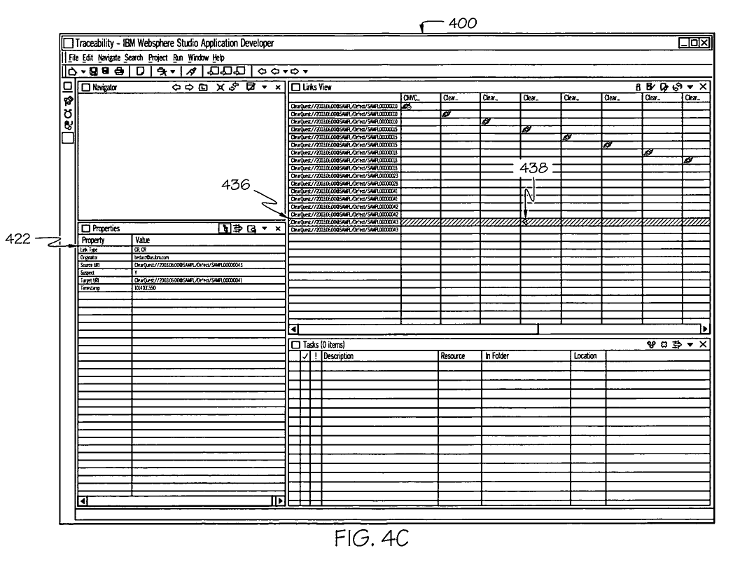

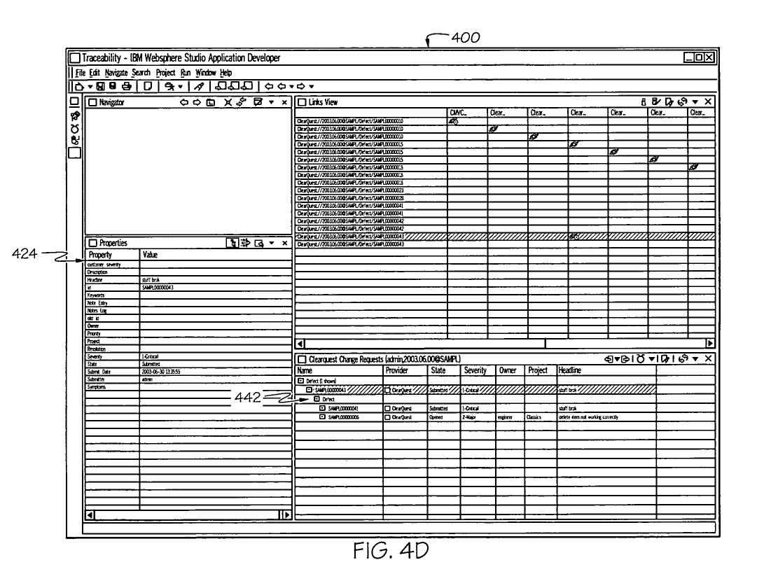

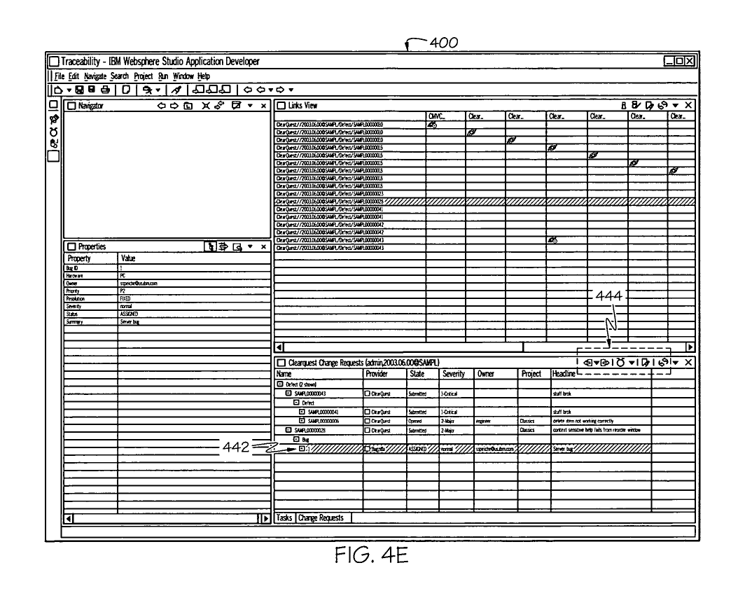

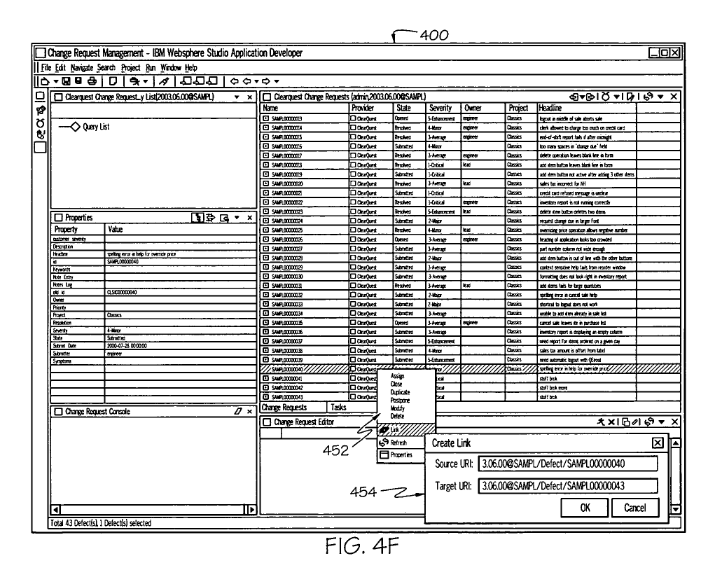

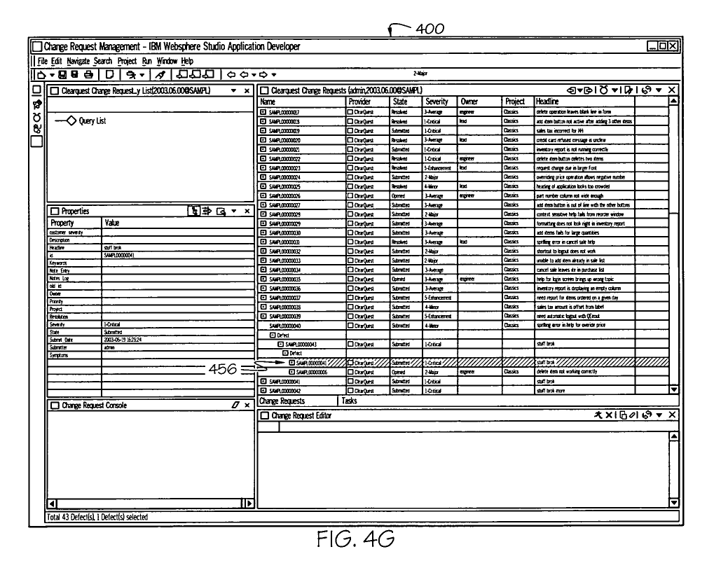

FIGS. 4A-4G are example screens of display of traceability tool user interfaces in accordance with exemplary aspects of the present invention. More particularly, FIG. 4A depicts traceability tool interface window 400, which comprises navigator display portion 410, properties display portion 420, links view portion 430, and tasks display portion 440. A user, such as a developer, may switch to the traceability perspective shown in FIG. 4A by selecting button 402, for example.

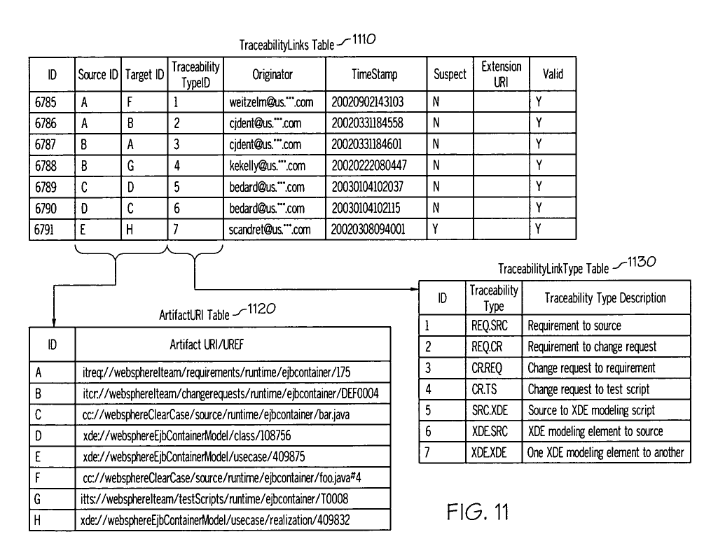

FIG. 4B depicts a query wizard interface in accordance with exemplary aspects of the present invention. The developer opens the query wizard by selecting query button 432, which causes traceability query wizard dialog 434 to be presented. The developer selects a query type, in this case “Link Type,” which causes traceability query wizard dialog 462 to be presented. In this dialog, the developer chooses a link type and selects “Finish” button to execute the query. The query types presented in dialog 462 may be as shown in traceability link type table 1130 in FIG. 11, for example.

FIG. 4C depicts example traceability tool interface window 400, which presents a links view. Suspect link indicator 438 identifies traceability link 436 as a suspect link. A developer may select suspect link 436. The link information is presented in display portion 422. The link information is integrated with the native property sheet of the integrated development environment. FIG. 4D illustrates seamless tool integration and navigation in accordance with exemplary aspects of the present invention. If the developer double-clicks the suspect link, the corresponding artifact information 442 is opened using the standard integrated development environment tools associated with the artifact, and artifact information 442 is presented in tasks display portion 440. Linked artifacts are also presented in tasks display portion 440. Property sheet 424 reflects the artifact information.

The traceability engine may also link multiple tools. FIG. 4E illustrates seamless integration across heterogeneous tools in accordance with exemplary aspects of the present invention. Using integrated development tools, the developer is able to see which code artifacts are linked to bug artifacts, for example. In the depicted example, traceability link 442 shows that bug “1” is linked to code “SAMPL00000028.” Furthermore, as shown in FIG. 4E, controls 444 allow a user to add, delete, or modify traceability links.

FIG. 4F depicts extended tools for traceability in accordance with exemplary aspects of the present invention. A developer may right-click on an artifact to generate context menu 452. Selecting the “Link” option causes context-aware traceability dialog box 454 to open requesting the URI/UREF of the target artifact to create a new traceability link. The source URI/UREF is pre-filled. As shown in FIG. 4G, if the developer expands the artifact in the traceability links display portion, the newly created link 456 between artifacts is presented.

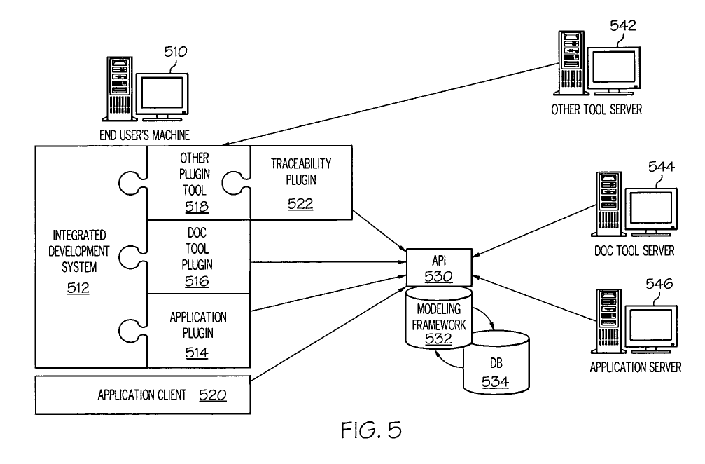

FIG. 5 is a block diagram illustrating a model based traceability engine exposed in an application programming interface and persisted in a database in accordance with exemplary aspects of the present invention. End user's machine 510 has running thereon integrated development environment 512. Integrated development system 512 may have a plurality of plugin tools, such as application plugin 514, documentation tool plugin 516, and other plugin tool 518. Integrated development system 512 may be, for instance, software based on the Eclipse open source technology. End user's machine 510 may also have running thereon application client 520.

Application client 520 and application plugin 514 communicate with application server 546. In the depicted example, the application may be a defect tracking, requirements, test management, and version control application. Documentation tool 516 communicates with documentation tool server 544. Documentation tool 516 is an example of a tool that may cause artifacts to be generated. Therefore, documentation tool 516 is a candidate for traceability functionality. Similarly, other tool plugin 518 communicates with other tool server 542. A bug report plugin tool may be an example of other plugin tool 518. Such a plugin tool may be a candidate for traceability functionality in accordance with exemplary aspects of the present invention.

In the depicted example, traceability plugin 522 is a plugin to other plugin tool 518. The Eclipse open source technology allows a plugin to piggyback onto another plugin. In alternative embodiments, traceability functionality may be provided in a standalone application or integrated within a tool plugin, such as application plugin 514, documentation tool plugin 516, or other plugin tool 518. Alternatively, traceability functionality may be provided within integrated development system 512.

Application programming interface (API) 530 exposes model framework 532, i.e. the table schema, to tools, such as application plugin 514, documentation tool plugin 516, and traceability plugin 522, as well as servers, such as documentation tool server 544 and application server 546. Application client 520, application plugin 514, and application server 546 can leverage API 530 for creating from-to-who traceability, as well as read, query, update, and delete traceability links. The table schema and the traceability link information are persisted in database 534. Other tools, such as documentation tool plugin 516 and documentation tool server 544 can leverage API 530 for traceability.

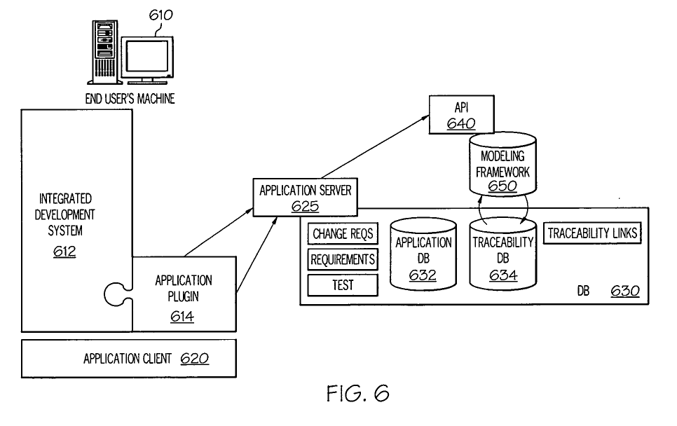

FIG. 6 is a block diagram illustrating a model based traceability engine providing traceability via a database instance in accordance with exemplary aspects of the present invention. End user's machine 610 has running thereon integrated development environment 612. Integrated development system 612 may have one or more plugin tools, such as application plugin 614. Integrated development system 612 may be, for instance, software based on the Eclipse open source technology. End user's machine 610 may also have running thereon application client 620.

Application client 620 and application plugin 614 communicate with application server 625. As stated above, application client 620, application plugin 614, and application server 625 may provide defect tracking, requirements, test management, and version control functionality, for example. Application programming interface (API) 640 exposes model framework 650, i.e. the table schema, to application server 625. Application client 620 and application plugin 614 access traceability functionality through application server 625, which can leverage API 640 for creating from-to-who traceability. Application client 620 and application plugin 614 can read, query, update, and delete traceability links. Application database 632 may store artifacts, such as change requests, requirements, and tests, for example. The table schema and the traceability link information are persisted in database 634. Application database 632 and traceability database 534 may be on the same database server machine 630. Alternatively, traceability database 634 may reside on a different machine.

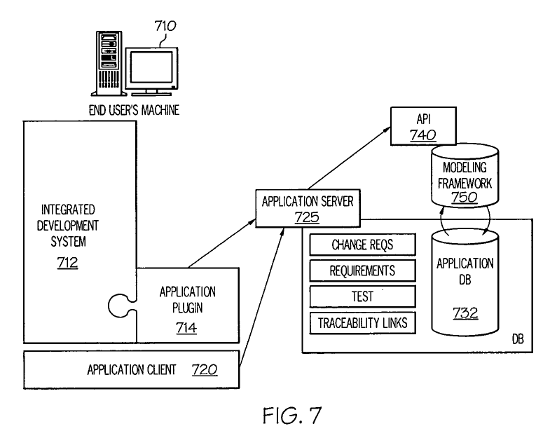

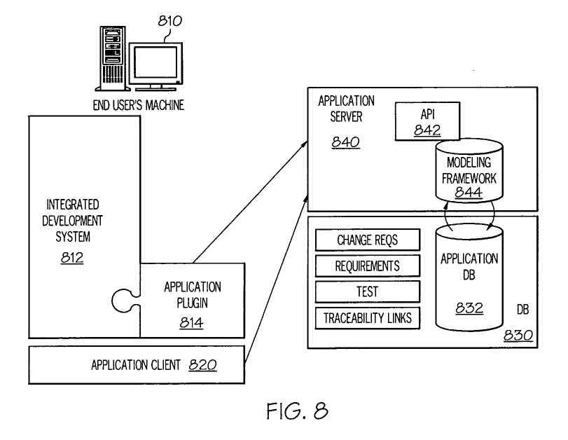

FIG. 7 is a block diagram illustrating a model based traceability engine providing traceability on the same database instance with a different schema qualifier in accordance with exemplary aspects of the present invention. End user's machine 710 has running thereon integrated development environment 712. Integrated development system 712 may have one or more plugin tools, such as application plugin 714. Integrated development system 712 may be, for instance, software based on the Eclipse open source technology. End user's machine 710 may also have running thereon application client 720.

Application client 720 and application plugin 714 communicate with application server 725. Application programming interface (API) 740 exposes model framework 750 to application server 725. Application client 720 and application plugin 714 access traceability functionality through application server 725, which can leverage API 740 for creating from-to-who traceability, as well as read, query, update, and delete traceability links. Application database 732 may store artifacts, such as change requests, requirements, and tests, for example. The traceability link information is also persisted in database 732.

FIG. 8 is a block diagram illustrating a model based traceability engine providing traceability on the same database instance with a custom schema in accordance with exemplary aspects of the present invention. End user's machine 810 has running thereon integrated development environment 812. Integrated development system 812 may have one or more plugin tools, such as application plugin 814. Integrated development system 812 may be, for instance, software based on the Eclipse open source technology. End user's machine 810 may also have running thereon application client 820.

Application client 820 and application plugin 814 communicate with application server 840. Application programming interface (API) 842 exposes model framework 844 to application server 820. In this depicted example, traceability is provided on the same machine in the same instance of the database with custom schema. Traceability functionality is embedded within the using application, in this case application client 820 and application plugin 814. Application server 840 can leverage API 842 for creating from-to-who traceability, as well as read, query, update, and delete traceability links. Application database 832 may store artifacts, such as change requests, requirements, and tests, for example. The traceability link information is also persisted in database 832.

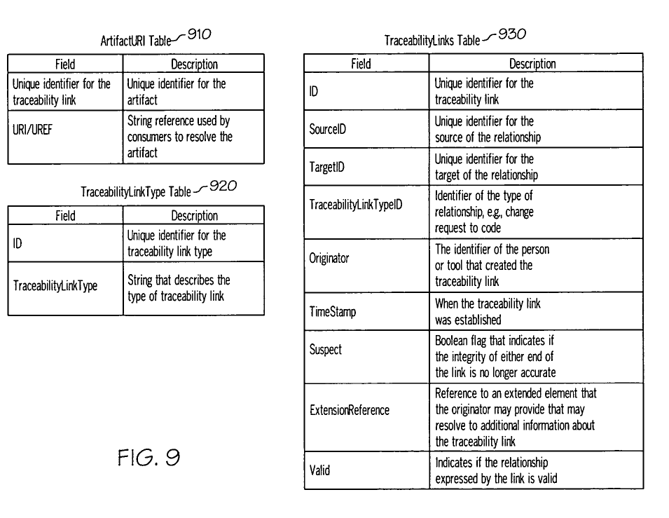

FIG. 9 illustrates example table schemas for model based traceability in accordance with exemplary aspects of the present invention. Artifact URI table 910 defines the fields used to define an artifact. Traceability link type table 920 defines the fields used to define traceability link types. Traceability links table 930 defines the fields used to define traceability links. Together, the tables in the depicted example form a table schema, which serves as the model for creating, updating, and querying traceability links.

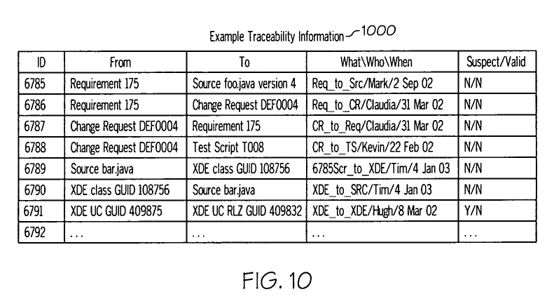

FIG. 10 depicts an example of traceability information in accordance with exemplary aspects of the present invention. Example traceability information 1000 includes an identifier (ID) of an artifact, where the artifact traces from, where the artifact is traceable to, what/who/when information, whether the traceability information is suspect, and whether the traceability information is valid.

FIG. 11 illustrates a physical view of example tables formed from traceability information 1000 in accordance with exemplary aspects of the present invention. Traceability links table 1110 identifies the ID for an artifact, the source ID and target ID of the artifact, the traceability type ID, the originator, a time stamp, whether the traceability link is suspect, and whether the traceability link is valid. Traceability links table 1110 also includes a field for extension URI. The source ID and target ID refer to artifact URI table 1120, which associates an artifact ID with the artifact URI/UREF. The traceability type ID refers to traceability link type table 1130, which associates a traceability type ID with a traceability type and description.

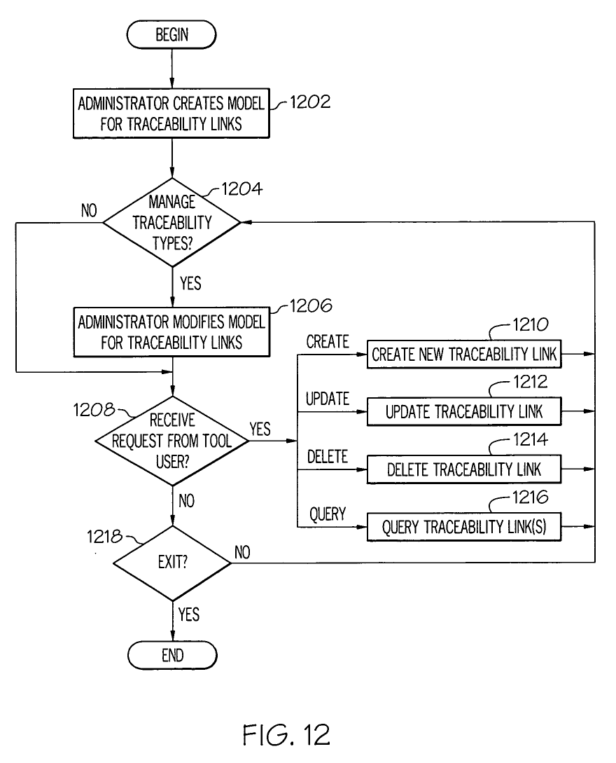

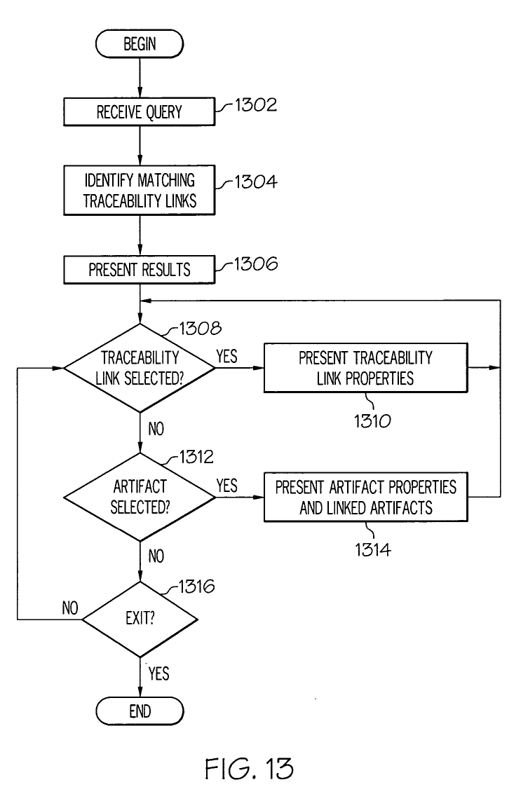

FIG. 12 is a flowchart illustrating operation of a traceability application in accordance with exemplary aspects of the present invention. FIG. 13 is a flowchart illustrating the operation of querying traceability links in accordance with exemplary aspects of the present invention. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory, transmission medium, or storage medium that can direct a processor or other programmable data processing apparatus to function in a particular manner, such that the instructions stored in the computer-readable memory, transmission medium, or storage medium produce an article of manufacture including instruction means which implement the functions specified in the flowchart block or blocks.

Accordingly, blocks of the flowchart illustrations support combinations of means for performing the specified functions, combinations of steps for performing the specified functions and computer usable program code for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

With particular reference to FIG. 12, operation of a traceability application is illustrated. Operation begins and an administrator creates a model for traceability links (block 1202). The traceability application determines whether the administrator makes a request to manage traceability types (block 1204). If the administrator requests to manage traceability types, the traceability application allows the administrator to modify the model for traceability links (block 1206). Thereafter, operation proceeds to block 1208. If the administrator does not request to manage traceability types in block 1204, operation proceeds directly to block 1208.

In block 1208, the traceability application determines whether a request is received from a traceability tool user. A request in block 1208 may be a create request, an update request, a delete request, or a query request. If a create request is received, the traceability application creates a new traceability link according to information in the request (block 1210) and operation returns to block 1204 to determine whether the administrator request to manage traceability types. If an update request is received, the traceability application updates a traceability link according to information in the request (block 1212) and operation returns to block 1204 to determine whether the administrator request to manage traceability types. If a delete request is received, the traceability application deletes a traceability link according to information in the request (block 1214) and operation returns to block 1204 to determine whether the administrator request to manage traceability types.

If a query request is received in block 1208, the traceability application queries traceability links according to information in the request (block 1216) and operation returns to block 1204 to determine whether the administrator request to manage traceability types. Operation of querying traceability links is described in further detail with reference to FIG. 13 below.

If the traceability application does not receive a request form a traceability tool user in block 1208, the traceability application determines whether an exit condition exists (block 1218). An exit condition may exist, for example, if the traceability application exits. If an exit condition exists, operation ends; otherwise, operation returns to block 1204 to determine whether the administrator requests to manage traceability types.

With reference now to FIG. 13, operation of querying traceability links is illustrated. Operation begins and the traceability application receives a query (block 1302). The traceability application then matches matching traceability links (block 1304) and presents the results to the requester (bock 1306).

Next, the traceability application determines whether a traceability link is selected (block 1308). If a traceability link is selected, such as by clicking on a traceability link in the display with a mouse, for example, the traceability application presents traceability link properties (block 1310). Thereafter, operation returns to block 1308 to determine whether a traceability link is selected.

If a traceability link is not selected in block 1308, the traceability application determines whether an artifact is selected (block 1312). If an artifact is selected, such as by double-clicking a traceability link in the display with a mouse, for example, the traceability application presents artifact properties and linked artifacts (block 1314). Thereafter, operation returns to block 1308 to determine whether a traceability link is selected.

If an artifact is not selected in block 1308, the traceability application determines whether an exit condition exists (block 1316). An exit condition may exist, for example, if the traceability application exits or if the traceability tool user submits another request or query. If an exit condition exists, operation ends returning to the operation shown in FIG. 12; otherwise, operation returns to block 1308 to determine whether a traceability link is selected.

Thus, the present invention solves the disadvantages of the prior art by providing a model based traceability framework in an integrated development environment. The model based framework is embeddable, or deployable, in any application or plugin within the integrated development environment. A database provides scalable persistence of the model and traceability links created using the model. The framework comprises an underlying model that is created by an administrator through a table schema. Tools using the framework allow the creation and management of traceability links, which may be created during code generation or manually through a user interface. The tools allow a user to query traceability links by ID, URI/UREF, traceability type, and who/what/when criteria, for example.

An administrator manages the model by creating and maintaining artifact information, traceability link types, and traceability link information in tables. Traceability link types may include, for example, artifact-to-artifact links, model-to-model links, model-to-code links, and artifact-to-model/code links. A traceability tool, which may a standalone application or a plugin to an existing tool, allows users to create, update, and delete traceability links. The traceability tool may also allow users to query traceability links. In addition, the traceability tool may mark links as suspect.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for model based traceability, the computer implemented method comprising:
providing a traceability model;
creating a plurality of traceability links based on the traceability model; and
providing a tool for managing the plurality of traceability links.

2. The computer implemented method of claim 1, wherein the traceability model comprises a plurality of tables that form a schema.

3. The computer implemented method of claim 2, wherein the plurality of tables comprise an artifact table, a traceability link type table, and a traceability links table.

4. The computer implemented method of claim 3, wherein the traceability link type table defines a plurality of traceability types comprising artifact-to-artifact links, model-to-model links, model-to-code links, and artifact-to-model/code links.

5. The computer implemented method of claim 1, wherein creating a plurality of traceability links comprises:
receiving traceability information;
creating an artifact table based on the model and the traceability information;
creating a traceability link type table based on the model and the traceability information; and
creating a traceability links table based on the model and the traceability information, wherein the traceability links table references the artifact table for a source and a target for each traceability link in the traceability links table and references the traceability link type table for a traceability type for each traceability link in the traceability links table.

6. The computer implemented method of claim 5, wherein each entry of the traceability links table identifies for a given traceability link an identifier, a source artifact, a target artifact, and a traceability type.

7. The computer implemented method of claim 6, wherein each entry of the traceability links table further identifies for the given traceability link an originator, a time stamp, whether the given traceability link is suspect, or whether the given traceability link is valid.

8. The computer implemented method of claim 1, further comprising:
responsive to selection of a given traceability link, presenting artifact information for the given traceability link.

9. The computer implemented method of claim 1, further comprising:
receiving a traceability links query;
identifying a set of traceability links that satisfy the traceability links query; and
presenting the set of traceability links.

10. The computer implemented method of claim 9, further comprising:
identifying a suspect traceability link within the set of traceability links; and
presenting a suspect link identifier in association with the suspect traceability link.

11. A traceability system comprising:
an application module;
a model framework, wherein the model framework provides a traceability model;
an application programming interface, wherein the application programming interface exposes the traceability model to the application module; and
a database,
wherein the application module creates a plurality of traceability links based on the traceability model and provides a tool for managing the plurality of traceability links, and wherein the database stores the plurality of traceability links.

12. The traceability system of claim 11, wherein the application module is a client application, an application plugin to an integrated development environment, or a server application.

13. The traceability system of claim 11, wherein the database stores artifacts for generated by the application module.

14. A computer program product for model based traceability, the computer program product comprising:
a computer usable medium having computer usable program code, the computer usable program code comprising:
computer usable program code configured to provide a traceability model;
computer usable program code configured to create a plurality of traceability links based on the traceability model; and
computer usable program code configured to provide a tool for managing the plurality of traceability links.

15. The computer program product of claim 14, wherein the traceability model comprises a plurality of tables that form a schema.

16. The computer program product of claim 15, wherein the plurality of tables comprise an artifact table, a traceability link type table, and a traceability links table.

17. The computer program product of claim 14, wherein the computer usable program code configured to create a plurality of traceability links comprises:
computer usable program code configured to receive traceability information;
computer usable program code configured to create an artifact table based on the model and the traceability information;
computer usable program code configured to create a traceability link type table based on the model and the traceability information; and
computer usable program code configured to create a traceability links table based on the model and the traceability information, wherein the traceability links table is references the artifact table for a source and a target for each traceability link in the traceability links table and references the traceability link type table for a traceability type for each traceability link in the traceability links table.

18. The computer program product of claim 17, wherein each entry of the traceability links table identifies for a given traceability link an identifier, a source artifact, a target artifact, and a traceability type.

19. The computer program product of claim 14, further comprising:
computer usable program code configured to present artifact information for the given traceability link responsive to selection of a given traceability link.

20. The computer program product of claim 14, further comprising:
computer usable program code configured to receive a traceability links query;
computer usable program code configured to identify a set of traceability links that satisfy the traceability links query; and
computer usable program code configured to present the set of traceability links.
